(19) United States
(12) Patent Application Publication
(10) Pub. No.: US 2006/0070956 A1
(43) Pub. Date: Apr. 6, 2006

(54) Liquid filter

(75) Inventors: Ralf Herrmann, Sachsenheim (DE); Helmuth Fischer, Besigheim (DE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GmbH, Ludwigsburg (DE)

(21) Appl. No.: 11/239,382

(22) Filed: Sep. 30, 2005

(30) Foreign Application Priority Data
Oct. 4, 2004 (DE) 10 2004 048 565.8

(51) Int. Cl. B01D 17/02

(52) U.S. Cl. 210/744; 210/799; 210/104; 210/112; 210/171

(57) ABSTRACT

A liquid filter, particularly for filtering diesel fuel, having a device for automatically discharging water separated from the fuel in the liquid filter, including a housing with an inlet and an outlet for the liquid to be filtered, a filter element arranged in a sealed manner between the inlet and the outlet, and a water collecting area underneath the filter element, in which the automatic water discharge device is connected in a sealed manner to the housing below the water collecting area, and includes in a single housing a sensor for sensing the water level in the water collecting area, an electrically operated water discharge device for discharging water from the water collecting area, a water outlet, and a microprocessor operatively connected to the sensor, to the water discharge device and to a control unit of the internal combustion engine, such that in a predetermined operational state of the internal combustion engine while the engine is running, the microprocessor activates the water discharge device when the sensor emits an appropriate signal indicating water in the collecting area.

### BACKGROUND OF THE INVENTION

The present invention relates to a liquid filter having an automatic water discharge and to a method for automatically discharging water from such a liquid filter.

The fuel for internal combustion engines is normally filtered before being used for operation of the internal combustion engine. Since the water contained in the fuel may cause damage due to oxidation of the metal parts with which it comes in contact, it is well known that the water content of fuel must be filtered out in the fuel filter, especially in the case of diesel fuel filters. Due to the greater specific gravity of water, the water then collects in a water collecting tank in a lower area of the fuel filter. As soon as the water level in the filter has reached a certain height, the water must be removed from the filter to prevent the filter from malfunctioning.

U.S. Pat. No. 6,783,665 (=WO 01/33069) discloses a fuel filter with a water collecting chamber situated beneath the filter element and a housing situated above it, in which a multipart water level sensor is situated at one end in the bottom housing and at the other end in the water collecting chamber and is connected to a microprocessor arranged in the housing and a water discharge device which is also arranged in the housing. The microprocessor is also connected to the ignition lock, and the water discharge device and the water level sensor are connected to the electric system of the vehicle. Water discharge is activated by a corresponding signal of the water level sensor via the microprocessor in ignition lock position 1, i.e., when the electric system is supplying power but the engine is not running. The water discharge is stopped after a predetermined period of time or when the ignition lock is operated to start or remove the ignition key.

One disadvantage of the arrangement described above is that due to the combination of parts which are movable relative to each other, the water level sensor in this embodiment is susceptible to damage from vibration or contamination, and thus the sensor might not give water level messages that conform to reality. Another disadvantage is that the discharge of water takes place only when the engine stopped and the ignition is in position 1, which requires a delay in the operating sequence to provide time for any discharge of water. Consequently, the driver of the vehicle must also be informed unmistakably (e.g., via an LED) that the maximum permissible water level has been reached and that the vehicle must not be started immediately, but instead must wait for a while in ignition position 1.

### SUMMARY OF THE INVENTION

Accordingly, it is an object of the invention to provide an improved liquid filter having an automatic water discharge.

Another object of the invention is to provide a liquid filter with an automatic water discharge which more reliably senses the water level in the filter.

A further object of the invention is to provide a liquid filter with an automatic water discharge which will reliably discharge accumulated water without requiring a delay in the operating sequence of the engine.

It is also an object of the invention to provide an improved method for discharging separated water from a liquid filter.

These and other objects are achieved in accordance with the present invention by providing a liquid filter having an automatic water discharge for discharging water separated from a liquid to be filtered in the liquid filter, said filter comprising a filter housing with at least one inlet and at least one outlet for the liquid to be filtered, a filter element arranged in a sealed manner between said at least one inlet and said at least one outlet, and a water collecting area disposed below the filter element, wherein the automatic water discharge is connected in a sealed manner to the filter housing beneath the water collecting area, said automatic water discharge comprising a single housing in which are arranged a sensor for sensing the water level in the water collecting area, an electrically operated water discharge device for discharging water from the water collecting area, a water outlet, and a microprocessor which is operatively connected to the water level sensor, to the water discharge device and to a control unit of the internal combustion engine such that the microprocessor activates the water discharge device when the water level sensor senses water in the water collecting area.

In accordance with a further aspect of the invention, the objects are achieved by providing a method for separating water from a liquid having a lighter density, said method comprising passing the liquid from which water is to be separated through a filter element which passes the liquid but not the water so that the water separates from the liquid; collecting separated water in a water collecting area disposed underneath the filter element; sensing the water level in the water collecting area with a water sensor, and transmitting a signal indicating the sensed water level to a microprocessor in an automatic water discharge connected to the water collecting area, the automatic water discharge comprising a single housing in which are arranged the sensor for sensing the water level in the water collecting area, an electrically operated water discharge device for discharging water from the water collecting area, a water outlet, and the microprocessor which is operatively connected to the water level sensor and to the water discharge device; and when the sensed water level in the water collecting area reaches or exceeds a predetermined maximum, the microprocessor activating the water discharge device to discharge water from the water collecting area through the water outlet.

The liquid filter according to the invention, in particular a diesel fuel filter for an internal combustion engine, is equipped with an automatic discharge for water separated in the liquid filter. The liquid filter has a housing having at least one inlet and at least one outlet for the liquid to be filtered and a filter element situated in a sealed manner between the inlet and the outlet. The housing may be designed to be round, oval or angular and the filter element may be designed as a hollow cylindrical filter element, a filter element pleated in zigzag pleats or a coiled filter element, in which a filter paper or synthetic filter medium may be used as the filter medium.

A water collecting area is situated beneath the filter element in the housing and is preferably connected to the oncoming flow side of the filter element because the water separation is preferably accomplished on the filter element. The water collecting area has at least one opening in the lower area, through which the lower area of the water collecting area is connected in a sealed manner to a device for automatic water discharge.

The automatic water discharge has a sensor in a single housing for sensing the water level in the water collecting area, extending into the lower area of the water collecting area through the opening which is in this area. In addition, the housing contains a water outlet and an electrically operated water discharge device for discharging water from the water collecting area. In a pressurized system or elevated pressure system, the electrically operated water discharge device may consist solely of an electrically operated valve, and in a vacuum system or a system operated at reduced pressure, the water discharge device may comprise a combination of an electric or electromagnetic pump and an electrically operated valve. An elevated pressure system means that the liquid filter is arranged in the path of flow downstream from the fuel pump, and a reduced pressure system means that the liquid filter is situated in the path of flow upstream from the fuel pump.

The sensor for sensing the water level and the electrically operated water discharge device are operatively connected to a microprocessor, which is also provided in the housing and which is additionally connected to a control unit of the internal combustion engine. The control unit may be the engine control unit of the internal combustion engine itself or an individual control unit operatively connected to the engine control unit. Upon receiving an appropriate message from the water level sensor in a predetermined operational state of the internal combustion engine which is determined by the control unit, the microprocessor activates the water discharge device.

The water collecting area may be constructed in one piece as part of the housing of the liquid filter or it may be a preferably hollow cylindrical component connected in a sealed manner to the housing in a lower part of the liquid filter. The water discharge advantageously takes place during normal operation of the internal combustion engine, so that there need not be any waiting time before starting the internal combustion engine, and it is not possible to inadvertently forget to empty the water tank because when the water collecting area is full and the internal combustion engine is in a certain operational state, e.g., depending on the load or rpm, fully automatic discharge of water is performed independently of any measures taken by the driver of the internal combustion engine.

Due to the concentration of functional elements in a single housing, a simple intervention also is possible in the event of maintenance or repairs. Designing the water level sensor without any parts which move relative to each other arranged in different housing parts provides even greater functional reliability. The sensor may be constructed as a capacitive sensor, a conductivity sensor, or as a float, or any other device known in the art for sensing a liquid level may be used for sensing the water level.

In accordance with one advantageous embodiment of the invention, a liquid heating system also is arranged underneath the water collecting area in or adjacent to the housing of the water discharge device. This may be, for example, a positive temperature coefficient (PTC) heating element or a plastic heater. In a PTC heating element, the resistance decreases as heat is drawn away so that the heating element self-regulates at a predetermined temperature and varies its wattage automatically in order to maintain the predetermined temperature. In a plastic heater, heating contacts are connected by an electrically conductive synthetic resin material. When a voltage is applied to the heating contacts, the plastic provided between the heating rods heats up due to its low electric resistance. The heater may protrude into the interior of the filter housing and may thus heat the liquid in direct contact with it or it may also be arranged on the outside of the filter housing and may cause heating of the liquid via thermal conduction through the housing.

The liquid heater is also operatively connected to a liquid temperature sensor which senses the temperature of the liquid in the interior of the housing. When the temperature of the liquid to be filtered drops below a predetermined temperature, the liquid heater is activated until a specified temperature is reached again. This is necessary to avoid an increase in viscosity of the liquid due to the temperature being too low and a resulting blockage of the filter element. The liquid temperature sensor may be connected to the microprocessor, for example, in which case the microprocessor then controls the activation and deactivation of the heater as a function of specified characteristics.

In another embodiment, the water discharge device includes a pump, preferably an electromagnetic pump, and an electric or electromagnetic valve. In this case the electromagnetic valve preferably assumes an additional safety function, such that the existence of an elevated pressure in the interior of the system at the same time also results in an increase in the closing pressure of the valve seat. Thus, no liquid can reach the outside of the liquid filter, even when there is an undesirably elevated pressure in the system. The electromagnetic valve and the electromagnetic pump are both operatively connected to the microprocessor such that when the water discharge is activated by the microprocessor, the pump conveys the water out of the water collecting area and through the opened valve and then the pump and the valve form a redundant safety system against leakage from the liquid filter. If liquid continues to pass through the pump to the valve due to an electric malfunction, the safety function inherent in the valve will nevertheless prevent liquid from being discharged from the liquid filter. The pump is preferably constructed as an electromagnetic piston pump, and security with respect to unwanted leakage of the pump is also provided by various non-return valves in the interior.

It is also advantageous to arrange a filter for filtering the water to be discharged upstream from the automatic water discharge device in order to keep any particles that might be present on the unfiltered liquid side away from the water discharge device and thereby prevent damage to the sealing seats and valve gaskets present in the pump and in the valve due to particles and thereby prevent leakage. The filter may be a round filter element like a round filter connected upstream from the water discharge device, similar to a passive fuel filter, or an extremely fine mesh metal grating or metal cloth which is arranged directly in the inlet of the water discharge device and is attached there in a sealed manner. Here again there is an advantage in direct mounting on the housing of the water discharge device so that existing liquid filters can be retrofitted with this water discharge module without having to carry out any significant alterations on the liquid filter itself.

One possibility for disposing of separated water is to connect the water outlet of the housing of the water discharge device to a membrane for separation of fuel still present in the water, so that cleaned water purified in this way can then be discharged to the environment through a line. Due to the different chemical and physical properties of water and fuel, it is possible to separate these two liquids by using a suitable membrane, in which case the water, which has then been freed of fuel, contains virtually no harmful foreign components any longer and therefore can be discharged to the environment, while the fuel which has been freed of water can be returned to the fuel system.

According to an alternative embodiment of this invention, the water outlet is operatively connected to the intake system of the internal combustion engine. The discharged water together with the small amounts of fuel separated is injected into the intake manifold during operation of the internal combustion engine under the specified operating conditions. In the intake manifold it is atomized very finely during the intake process and drawn into the combustion chamber along with the fuel, where it ensures a drop in the temperature of combustion during the combustion process and thus leads to a decline in the formation of NOₓ gases. This measure thus has a very positive effect on the exhaust performance of the internal combustion engine.

Likewise, as an alternative, it is also possible to connect the water outlet to a tank for storing the discharged water-fuel mixture with a sealed connection. This tank should be large enough (a volume of approximately one liter to several liters is proposed here) so that the filling level of the tank can then be determined visually from the outside or can be relayed acoustically via a sensor or ascertained visually in the driver's compartment of the vehicle. The tank must then be emptied regularly according to a certain schedule or as indicated by the acoustic or visual indicator.

It is likewise possible to appropriately connect the water outlet to an inlet line into the exhaust system. The separated and discharged water can then be injected upstream from an existing catalytic converter during operation of the internal combustion engine to thereby lower the exhaust temperature and decrease the formation of NOₓ. However, it is likewise possible to inject the fuel-water mixture as close to the internal combustion engine as possible when there is no catalytic converter.

The method for automatic water discharge from a liquid filter as described above is divided into the following steps:

on the oncoming flow side of the filter element of the fuel filter, the water is separated from the fuel and then collects in the water collecting area below the fuel due to the greater density of the water,

a water level sensor transmits the water level prevailing in the water collecting area (or at least a minimum and maximum determination) to the microprocessor present in the water discharge housing,

the operational state of the internal combustion engine is also relayed to the microprocessor via a control unit provided in the internal combustion engine,

if there is correspondence between a predetermined operational state and simultaneous attainment or exceeding of the maximum water level, the microprocessor will activate the water discharge,

the water present in the water collecting area is discharged.

In accordance with one embodiment of this method, the temperature of the fuel is also detected by a temperature sensor situated in the liquid filter and is relayed to the microprocessor. When the temperature is at or below a predetermined limit temperature, the microprocessor activates a fuel heater which is also provided in the liquid filter and heats the fuel until the fuel present in the liquid filter has reached a predetermined fuel temperature.

In a vacuum system, i.e., a system with a liquid filter which is situated in the path of flow upstream from the fuel pump, redundant protection against leakage through the discharge valve is achieved by providing both an electromagnetic delivery pump and an electromagnetic discharge valve situated downstream in the direction of flow. In the event of pump failure due to a short circuit and/or mechanical failure, the discharge valve nevertheless remains tightly sealed and thus prevents water and fuel from escaping.

In accordance with one advantageous embodiment of this method, the water discharge is preferably turned off after a predetermined period of time has elapsed. Due to the characteristic quantities of the water discharge such as the volume flow rate and the water volume in the water collecting area up to the maximum water level, it is easy to specify a period of time within which the water present in the water collecting area will be completely discharged. If the volume flow of the water to be discharged deviates from expectations, then through a corresponding signal of the minimum water level sensor to the microprocessor, the water discharge may be shut down early before the specified period of time has elapsed. The microprocessor thus interrupts the time-controlled discharge of water as soon as the minimum water level has been reached to prevent any fuel from being discharged.

It may be advantageous to convey the separated water directly to the intake tract of the internal combustion engine through a line and inject the water into the intake airstream in at least one intake manifold. This injection also takes place during predetermined operational states and causes a reduction in the combustion temperature and consequently a reduction in pollutant emissions.

Alternatively, it is possible to supply the discharged water through a line directly to the engine exhaust pipe where it is added to the exhaust stream. Preferably, the mixing with the exhaust will take place upstream from the catalytic converter in exhaust systems equipped with a catalytic converter. In other systems, the mixing should occur close to the beginning of the exhaust pipe. This should also reduce the exhaust temperature and facilitate NOₓ reduction.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures in which:

FIG. 1 is a partially sectional front view of a liquid filter according to the present invention;

FIG. 2 is a sectional view taken along section line A-A of FIG. 1 in the vicinity of the water discharge, and FIG. 3 is a sectional view taken along section line B-B of FIG. 2 in the vicinity of the water discharge.

### DETAILED DESCRIPTION OF PREFERRED EMBODIMENTS

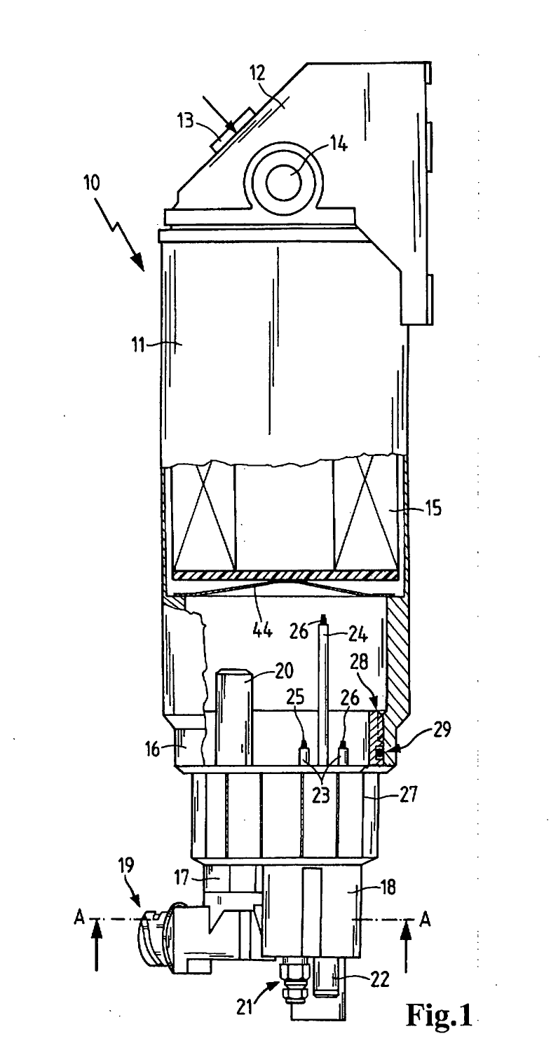

FIG. 1 is a partial sectional view of a liquid filter 10. The liquid filter 10 has a housing 11 with a housing head 12 and an inlet 13 and an outlet 14. A filter element 15 is arranged in a sealed manner between the inlet 13 and the outlet 14, supported by a cartridge guide 44 in the housing 11. Beneath the housing 11, a collecting tank 16 is arranged. Below the collecting tank 16 in turn there is a heater tank 17 and a water discharge device 18.

The heater tank 17 has a connecting plug 19 for connection to an electric power source and a PTC heater 20 which extends into the collecting tank 16. The heater tank 17 and the collecting tank 16 are connected to one another in a sealed manner. The water discharge device 18 has a cable feed 21, likewise for supplying electric power and for supplying signals from a control unit (not shown), and a water outlet 22. The water outlet 22 can be connected to other elements which are used to treat the discharged water, e.g., via a hose connection (not shown).

The water discharge device 18 is connected in a sealed manner to the collecting tank 16. Two short sensor rods 23 and a long sensor rod 24 are arranged in the upper area of the water discharge device 18 so that they extend into the collecting tank 16 to sense the water level. One of the short sensor rods 23 has a ground electrode 25 and the two other sensor rods 23, 24 each have positive electrodes 26 in the upper area.

The minimum and maximum water levels to be sensed in the collecting tank 16 are determined by the heights of the electrodes 25 and 26. To measure the water level, a negative voltage is applied once to the sensor rods 23, 24 in the interior of the water discharge device 18 and a positive voltage is applied twice or a negative voltage is applied twice and a positive voltage is applied once so that upon gradual filling of the collecting tank 16 with conductive water, the fact that a minimum water level has been reached can be sensed by a short circuit between the two short sensor rods 23, and upon reaching a maximum water level, an additional short circuit can be sensed between the long sensor rod 24 and the short ground sensor rod 23.

The heater tank 17 and the water discharge device 18 are shown here arranged in two separate housings, but it is also possible to accommodate these functional elements in a single housing under the collecting tank 16. The PTC heater 20 is a self-regulating heater, so that the resistance value changes as a function of the temperature and therefore overheating cannot occur. The temperature of the liquid in the liquid filter is measured by a temperature sensor (not shown) which may be situated anywhere in the housing 11, in the housing head 12 or in the collecting tank 16, and when the temperatures falls below a specified minimum or exceeds a specified maximum, the PTC heater is activated or deactivated accordingly.

The collecting tank 16 has a profiled outer contour 27 with which the collecting tank 16 can be connected to or released from the housing 11 using an appropriate tool or by hand via a thread 28 provided on the collecting tank 16. An O-ring 29 is provided in a groove on the collecting tank 16 to form a seal between the collecting tank 16 and the housing 11.

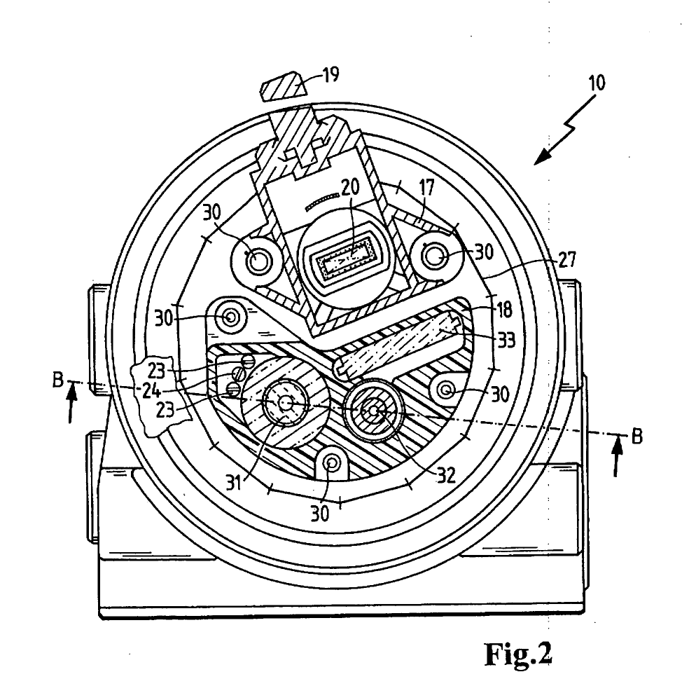

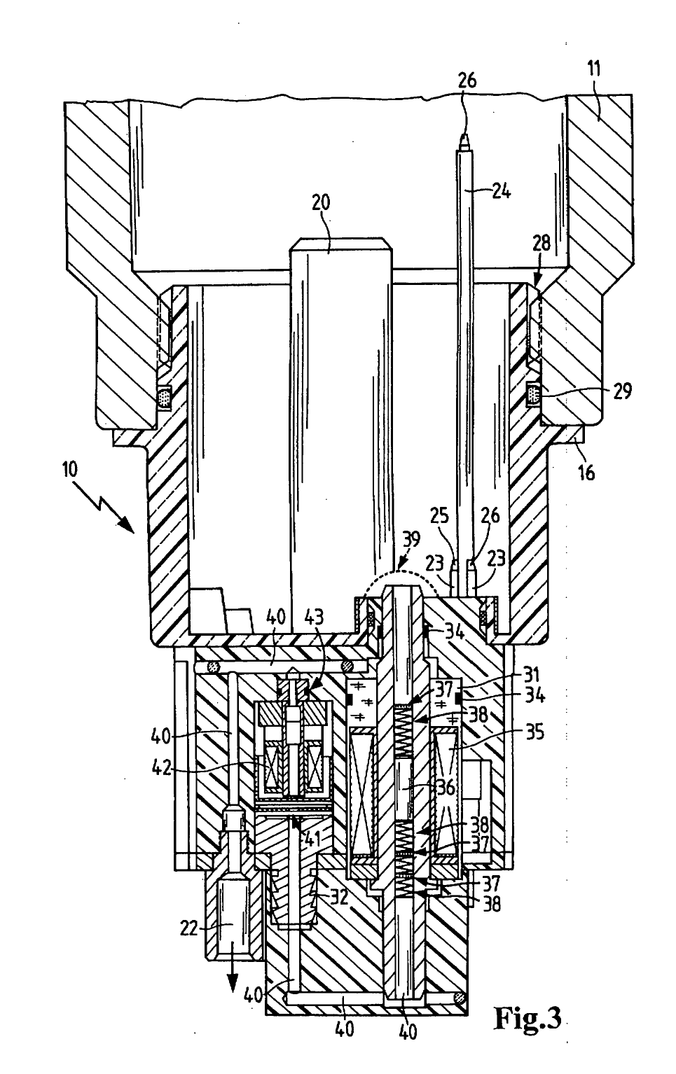

FIG. 2 is a sectional view through the liquid filter 10 taken along section line A-A of FIG. 1 in the area of the water discharge device 18. Components corresponding to those in FIG. 1 are identified by the same reference numerals. The heater tank 17 and the water discharge device 18 have mounting bores 30 through which these two housings 17, 18 are detachably joined to the collecting tank 16 (not shown). An electromagnetic pump 31, an electromagnetic valve 32 and a microprocessor 33 are provided in the water discharge device 18, with these units being supplied with electric power via the cable feed 21 shown in FIG. 1 and also operatively interconnected by cables.

When the microprocessor 33 receives a maximum water level signal from the sensors 23 and 24 through an appropriate signal from a control unit (not shown) and the internal combustion engine is in an appropriate operational state, then the microprocessor 33 delivers an appropriate signal to the pump 31 and the valve 32 to discharge water from the collecting tank 16. The heater 20 of the heater tank 17 may be actuated either by a direct signal from a temperature sensor (not shown) or it may be turned on and off via the microprocessor.

The exterior geometric shape of the water discharge device 18 and the heater tank 17 correspond externally to the geometric shape of the collecting tank 16 and correspond to one another at their points of contact so as not to protrude significantly beyond a projected surface of the liquid filter 10. In this way the space required for the liquid filter in the engine space can be kept to a minimum.

FIG. 3 is a sectional view through the liquid filter 10 taken along section line B-B of FIG. 2 in the area of the pump 31 and the valve 32 of the water discharge device 18. Again, components corresponding to those of the previous figures are identified by the same reference numerals. The pump 31 is arranged in the water discharge device 18 and is sealed relative to the housing by a seal material 34.

The pump 31 may advantageously be an electromagnetic solenoid driven oscillating piston pump which has a hollow cylindrical electromagnetic solenoid 35 which serves to propel the water to be discharged via a system of pistons 36, non-return valves 37 and springs 38 (depicted schematically). A pump of this type is a standard component and can be purchased commercially, for example, from the company Gotec S.A. of Sion, Switzerland. The water to be discharged is freed of coarse particles by a metal screen 39 and then flows through the channels 40, drawn by the self-priming electromagnetic pump 31, into the electromagnetic valve 32. Here again, there is an electromagnetic solenoid 42 which ensures opening and closing of the valve 32 via valve seat 41.

The valve 32 provides redundant protection against leakage through pump 31, and in elevated pressure systems which do not have a pump, actuation of the valve 32 alone is sufficient to achieve a water discharge. The valve 32 is also sealed with respect to the housing of the water discharge device 18 by a sealing medium 43.

The foregoing description and claims have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A liquid filter having an automatic water discharge for discharging water separated from a liquid to be filtered in the liquid filter, said filter comprising a filter housing with at least one inlet and at least one outlet for the liquid to be filtered, a filter element arranged in a sealed manner between said at least one inlet and said at least one outlet, and a water collecting area disposed below the filter element, wherein the automatic water discharge is connected in a sealed manner to the filter housing beneath the water collecting area, said automatic water discharge comprising a single housing in which are arranged a sensor for sensing the water level in the water collecting area, an electrically operated water discharge device for discharging water from the water collecting area, a water outlet, and a microprocessor which is operatively connected to the water level sensor, to the water discharge device and to a control unit of the internal combustion engine such that the microprocessor activates the water discharge device when the water level sensor senses water in the water collecting area.

2. A liquid filter according to claim 1, further comprising a liquid heater situated beneath the water collecting area in or adjacent the housing of the automatic water discharge, said liquid heater being operatively connected to a liquid temperature sensor such that when the temperature of the liquid to be filtered drops below a predetermined temperature, the heater is activated to heat the liquid, whereby an increase in viscosity of the liquid and resulting blockage of the filter element are prevented.

3. A liquid filter according to claim 1, wherein the water discharge device comprises a pump and an electrically operated valve, and said pump and valve are operatively connected to the microprocessor such that when the water discharge is activated, the valve is opened and the pump propels the water to be discharged from the water collecting area through the opened valve to the water outlet, whereby the pump and valve together form a redundant system for preventing leakage from the liquid filter.

4. A liquid filter according to claim 1, wherein a filter for filtering water to be discharged is connected to the single housing of the automatic water discharge such that any particles present in the water are filtered out upstream from water discharge device.

5. A liquid filter according to claim 1, wherein the water outlet is connected to a membrane separator for separating any fuel still present in the water to produce cleaned water, and cleaned water from the membrane separator is then discharged to the environment.

6. A liquid filter according to claim 1, wherein the water outlet is connected in a sealed manner to a water storage tank.

7. A liquid filter according to claim 1, wherein the water outlet is connected to an internal combustion engine intake manifold such that discharged water is injected into the intake manifold during operation of the internal combustion engine.

8. A liquid filter according to claim 1, wherein the water outlet is connected to an inlet opening into an internal combustion engine exhaust system such that discharged water is injected into an engine exhaust stream upstream from a catalytic converter.

9. A liquid filter according to claim 1, wherein the water outlet is connected to an inlet opening into an internal combustion engine exhaust system such that discharged water is injected into an engine exhaust stream as close as possible to the internal combustion engine during the operation of the internal combustion engine.

10. A liquid filter according to claim 1, wherein said filter is a diesel fuel filter for an internal combustion engine, and the microprocessor activates the water discharge device only when the internal combustion engine is running in a predetermined operational state and the water level sensor senses water in the water collecting area.

11. A method for separating water from a liquid having a lighter density, said method comprising:
passing the liquid from which water is to be separated through a filter element which passes the liquid but not the water, whereby the water separates from the liquid;
collecting separated water in a water collecting area disposed underneath the filter element;
sensing the water level in the water collecting area with a water sensor, and
transmitting a signal indicating the sensed water level to a microprocessor in an automatic water discharge connected to the water collecting area, said automatic water discharge comprising a single housing in which are arranged the sensor for sensing the water level in the water collecting area, an electrically operated water discharge device for discharging water from the water collecting area, a water outlet, and the microprocessor which is operatively connected to the water level sensor and to the water discharge device;
whereby, when the sensed water level in the water collecting area reaches or exceeds a predetermined maximum, the microprocessor activates the water discharge device to discharge water from the water collecting area through the water outlet.

12. A method according to claim 11, wherein the filter is upstream of a pump for conveying the liquid to be filtered such that a negative pressure prevails in the filter, and the water discharge device comprises an electrically operated pump and an electric valve.

13. A method according to claim 11, wherein the filter is downstream of a pump for conveying the liquid to be filtered such that a positive pressure prevails in the filter, and the water discharge device consists of only an electrically operated valve.

14. A method according to claim 11, wherein the filter is a fuel filter for a diesel internal combustion engine and the microprocessor of the automatic water discharge is operatively connected to a control unit for the engine, said method further comprising transmitting the operational state of the engine to the microprocessor, and activating the water discharge device only when the internal combustion engine is running in a predetermined operational state and the water level sensor senses water in the water collecting area.

15. A method according to claim 15, wherein the filter further comprises a heater for the liquid to be filtered and a temperature sensor for the liquid to be filtered, said method further comprising detecting the temperature of the liquid to be filtered, transmitting a signal indicating the detected temperature to the microprocessor, and the microprocessor activating the heater when the detected temperature of the liquid is below a predetermined minimum temperature and deactivating the heater when the detected temperature of the liquid reaches a predetermined target temperature.

16. A method according to claim 12, wherein the electric valve is normally closed when not supplied with electricity, whereby the valve prevents leakage from the automatic water discharge if electricity is not supplied to the filter.

17. A method according to claim 11, wherein the water discharge device is deactivated after a predetermined period of time or when a predetermined minimum water level is attained, whichever occurs first, whereby discharge of fuel through the water outlet is prevented.

18. A method according to claim 11, wherein the water outlet is connected to an intake manifold of an internal combustion engine, said method further comprising injecting discharged water into an intake airstream in the intake manifold.

19. A method according to claim 11, wherein the water outlet is connected to an exhaust system of an internal combustion engine, said method further comprising injecting discharged water into a stream of engine exhaust.

20. A method according to claim 19, wherein said exhaust system comprises a catalytic converter through which the stream of exhaust is passed, and the water is injected into the exhaust stream upstream of the catalytic converter.
